(19) United States
(12) Patent Application Publication
(10) Pub. No.: US 2013/0274363 A1
(43) Pub. Date: Oct. 17, 2013

(54) HYDROPHILIC POLYURETHANE FOAM

(71) Applicant: INOAC USA, INC, Troy, MI (US)

(72) Inventor: Fuminori Horio, Cresskill, NJ (US)

(21) Appl. No.: 13/860,748

(22) Filed: Apr. 11, 2013

Related U.S. Application Data
(60) Provisional application No. 61/623,844, filed on Apr. 13, 2012.

(51) Int. Cl. C08G 18/08

(52) U.S. Cl. CPC C08G 18/14
USPC 521/156

(57) ABSTRACT

A method for making hydrophilic polyurethane foam includes providing methylene diphenyl diisocyanate, mixing polyether polyols with the methylene diphenyl diisocyanate, and allowing the methylene diphenyl diisocyanate and the polyether polyols to form the hydrophilic polyurethane foam. The hydrophilic polyurethane foam has a content of ethylene oxide that is between about 30-100% by weight. The methylene diphenyl diisocyanate and polyols are mixed in a one-stage process. The hydrophilic polyurethane foam absorbs water in time period that is less than about 30 seconds.

### CROSS-REFERENCE TO RELATED PATENT APPLICATION(S)

This United States Non-Provisional Patent Application relies for priority on U.S. Patent Application Ser. No. 61/623,844, filed on Apr. 13, 2012, the contents of which are incorporated herein by reference.

### FIELD OF THE INVENTION

The present invention relates to polyurethane foams. More specifically, the present invention concerns hydrophilic polyether polyurethane foams that exhibit characteristics of rapid fluid absorption.

### BACKGROUND OF THE INVENTION

Conventional polyether and polyester polyurethane foams are hydrophobic. This means that these foams do not absorb water quickly (if at all).

As should be apparent to those skilled in the art, some applications for polyether and polyester polyurethane foams require that the foams exhibit hydrophilic properties. When a material is “hydrophilic,” this means that the material has an affinity for water and other fluids.

In the prior art, it is known to prepare hydrophilic polyurethane foams via a two-stage “prepolymer” process in which a hydrophilic prepolymer isocyanate end group is mixed and then reacted with water.

Such processes are disclosed in U.S. Pat. Nos. 3,861,993 and 3,889,417, the contents of both of which are incorporated herein by reference.

U.S. Pat. No. 3,861,993 (hereinafter “the '993 Patent”) describes a composite foam scouring pad formed of a reticulated hydrophilic crosslinked polyurethane foam disposed in combination with a nonreticulated hydrophilic crosslinked polyurethane foam. (The '993 Patent at the Abstract.) The '993 Patent describes that the reticulated hydrophilic foam may be prepared by capping polyoxyethylene polyol with a polyisocyanate such that the capped product has a reaction functionality greater than 2. (The '993 Patent at col. 1, lines 62-65.) The aqueous component may be water, a water emulsion, or a water solution having water soluble materials disposed therein. (The '993 Patent at col. 7, lines 58-60.) Reticulation of the foam is achieved by effecting a foaming reaction in the presence of a blowing agent and a particular surfactant. (The '993 Patent at col. 4, lines 7-10.)

U.S. Pat. No. 3,889,417 (hereinafter “the '417 Patent”) describes a method for preparing horticultural foam structures. Specifically, the '417 Patent describes the preparation of a hydrophilic polyurethane foam sheet by reacting an isocyanate capped polyoxyethylene polyol reactant with large amounts of aqueous reactant. (The '427 Patent at the Abstract.)

Separately, it is known to use a MDI (“methylene diphenyl diisocyanate”) prepolymer with an aqueous phase in a two-stage process to produce polyurethane foams.

U.S. Pat. Nos. 4,365,025 and 4,384,051, which are incorporated herein by reference, describe this two-stage process.

U.S. Pat. No. 4,365,025 (hereinafter “the '025 Patent”) describes a flexible polyurethane foams made from isocyanate containing prepolymers where the isocyanate is a mixture of diphenylmethane diisocyanate (“MDI”) and polymeric forms of MDI. (The '025 Patent at the Abstract.) The foams are produced by reacting water with the prepolymer and fire retardant materials to produce fire retardant foams. (The '025 Patent at the Abstract.)

U.S. Pat. No. 4,384,051 (hereinafter “the '051 Patent”) describes a flexible polyurethane foam based on MDI. The foam is produced by mixing together an aqueous phase, surfactants, and a resin phase including a prepolymer derived from a poly (oxy C₂₋₄alkylene) diol, and an MDI containing isocyanate product having a functionality greater than 2.0. (The '051 Patent at the Abstract.) The MDI containing isocyanate product may be made from a mixture of MDI and isocyanate containing derivatives of MDI and a polymeric poly (oxyC₂₋₄alkylene) polyol cross-linking agent having 3 or 4 hydroxyl equivalents per mole and a molecular weight of at least 500. (The '051 Patent at the Abstract.)

Other patents of interest include U.S. Pat. Nos. 5,650,450, 6,034,149, and 7,022,746, the contents of all of which are incorporated herein by reference.

U.S. Pat. No. 5,650,450 (hereinafter “the '450 Patent”) describes a hydrophilic urethane foam formed from the reaction product of an MDI-based or polymeric MDI-based isocyanate capped prepolymer with an aqueous component, such as water, and a silicone glycol copolymer liquid surfactant with a polyether portion. (The '450 Patent at the Abstract.) The surface of the hydrophilic foam wets out or absorbs droplets of water in less than thirty seconds, preferably instantaneously (less than 1 second). (The '450 Patent at the Abstract.)

U.S. Pat. No. 6,034,149 (hereinafter “the '149 Patent”) describes a hydrophilic polyurethane foam that is in a compressed state above its glass transition temperature and at ambient pressure in the absence of forces suitable to create the compressed state. (The '149 Patent at the Abstract.) Specifically, the described foams remain in a compressed state despite being above their glass transition temperature. (The '149 Patent at col. 1, lines 47-48.) The foams retain their wicking, absorptive, and retention properties despite being in a compressed state. (The '149 Patent at col. 1, lines 49-51.) The foams are prepared by reacting an excessive amount of polyisocyanate (such as MDI) with a polyetherpolyol with water. (The '149 Patent at col. 1, lines 57-67.)

U.S. Pat. No. 7,022,746 (hereinafter “the '746 Patent”) describes viscoelastic polyurethanes. The viscoelastic foams are based on a reaction system including a monomeric polyisocyanate composition, a specific mixture of polyols, and a specified package of additives. (The '746 Patent at the Abstract.)

Apart from MDI, TDI (“toluene diisocyanate”) also may be employed for the manufacture of polyurethane foams. As a general rule, TDI is used more frequently than MDI. However, MDI is known to be safer than TDI, because MDI is not considered to be a hazardous chemical. Moreover, because MDI is not considered to be a hazardous chemical, it is considered to be better for medical applications.

Whether MDI or TDI is employed, both traditionally rely on a two-stage process for the manufacture of the polyurethane foam. Concerning this two-stage manufacturing process, both MDI and TDI rely upon a “prepolymer” stage. As should be apparent to those skilled in the art, in the first stage, the prepolymer is prepared. In the second stage, the polyurethane foam is produced.

While these traditional methods are suitable for the preparation of hydrophilic polyurethane foams, a need remains for hydrophilic polyurethane foams that are simpler and more cost-effective to manufacture. Moreover, a need remains for ways to manufacture a hydrophilic polyurethane foam in simpler and more cost effective ways.

### SUMMARY OF THE INVENTION

The present invention addresses one or more of the deficiencies associated with respect to the prior art.

As discussed above, conventional hydrophilic polyurethane foam is produced via a two-step process. Conventional hydrophilic polyurethane foam is not formed via a one-shot process that includes only a single stage or step. Conventional manufacturing techniques involve two or more steps.

The present invention provides, as one aspect, a method of manufacture of hydrophilic polyurethane foam that involves only a single stage process.

The present invention also provides for a polyurethane foam made by a one-shot process, where the foam exhibits characteristics of rapid wicking, among other features.

In one contemplated embodiment, the present invention provides a method for making hydrophilic polyurethane foam that includes providing methylene diphenyl diisocyanate, mixing polyether polyols with the methylene diphenyl diisocyanate, and allowing the methylene diphenyl diisocyanate and the polyether polyols to form the hydrophilic polyurethane foam. The hydrophilic polyurethane foam has a content of ethylene oxide that is between about 30-100% by weight. The methylene diphenyl diisocyanate and polyols are mixed in a one-stage process. The hydrophilic polyurethane foam absorbs water in time period that is less than about 30 seconds.

In another contemplated embodiment, the content of the ethylene oxide is between about 50-100% by weight.

In still another embodiment, the content of the ethylene oxide is between about 70-100% by weight.

It is also contemplated that the content of the ethylene oxide is between about 80-100% by weight.

A further embodiment contemplates that the content of the ethylene oxide is between about 90-100% by weight.

Concerning the time period for the absorption of water, it is contemplated that the time period is less than about 20 seconds.

In another embodiment, it is contemplated that the time period is less than about 2 seconds.

Still further, it is contemplated that the time period is less than about 1 second.

In another embodiment, it is contemplated that the method excludes the use of any metal catalysts.

Another embodiment of the present invention contemplates adding a reactive type of amine catalyst to the methylene diphenyl diisocyanate and polyols.

The present invention also encompasses a hydrophilic polyurethane foam that includes methylene diphenyl diisocyanate and polyether polyols, where the hydrophilic polyurethane foam has a content of ethylene oxide that is between about 30-100% by weight. The methylene diphenyl diisocyanate and polyols are mixed in a one-stage process and the hydrophilic polyurethane foam absorbs water in time period that is less than about 30 seconds.

In various contemplated embodiments, the content of the ethylene oxide is between about 50-100% by weight, between about 70-100% by weight, between about 80-100% by weight, and between about 90-100% by weight.

With respect to the foam, the water absorption time period is contemplated to be less than about 20 seconds, less than about 2 seconds, and less than about 1 second.

The foam may be made without the use of any metal catalysts.

The foam may be made by adding a reactive type of amine catalyst to the methylene diphenyl diisocyanate and polyols.

Further advantages of the present invention will be made apparent from the discussion provided below.

### BRIEF DESCRIPTION OF THE DRAWING(S)

The present patent invention is described without reliance on any appended drawings.

### DETAILED DESCRIPTION OF EMBODIMENT(S) OF THE INVENTION

The present invention will now be described in connection with a process for the production of a hydrophilic polyurethane foam and a hydrophilic polyurethane foam produced thereby. In the discussion of the invention that follows, while focus may be placed on an aspect of the process and/or the foam material, the discussion is intended to apply equally to both the process for making the foam and the foam itself.

It is noted that the hydrophilic polyurethane foam of the present invention is understood, at least in one embodiment, to be an open-celled foam. The present invention, however, is intended to encompass closed-cell foams in addition to open-celled foams. Moreover, the present invention also encompasses foams that combine open-celled and closed-celled structures. In other words, the present invention should not be understood to be limited to a particular variety of foam material.

The present invention provides for a process for producing a hydrophilic polyurethane. Among other properties, the foam of the present invention exhibits rapid fluid absorption properties, which are also referred to as “rapid wicking” properties.

More specifically, the present invention provides a process for producing a rapid wicking, hydrophilic polyurethane foam by reacting a MDI-type isocyanate with high EO (“ethylene oxide”) content polyols via a one-shot forming method.

With respect to one embodiment of the invention, the EO content of the polyols is contemplated to be about 30-100% by weight. In an alternate embodiment, the EO content of the polyols is between about 50-100% by weight. In a further embodiment, the EO content of the polyols is between 70-100% by weight. In still another embodiment, the EO content of the polyols is between about 80-100% by weight. In a further embodiment, the EO content of the polyols is between 90-100% by weight.

In one embodiment of the present invention, the surface of the hydrophilic foam absorbs water droplets in less than 30 seconds. In another embodiment, the surface of the hydrophilic foam absorbs water droplets in less than 20 seconds, preferably instantaneously. The term “instantaneously” refers to an absorption time of less than about 2 seconds. More specifically, the term “instantaneously” or “substantially instantaneously” is intended to refer to an absorption time of about 1 second or less. In a broad sense, therefore, the present invention is intended to encompass embodiments of hydrophilic foam that absorbs water droplets in one of: (1) less than about 30 seconds, (2) less than about 20 seconds, (3) less than about 2 seconds, and (4) less than about 1 second.

As noted, the instantaneous (or substantially instantaneous) absorption properties of the hydrophilic foam of the present invention contemplates absorption of water in less than about 1 second. Absorption periods of less than one second are contemplated to fall within the scope of the present invention.

The present invention provides a hydrophilic polyurethane foam via a one-shot (or one step) process. Specifically, the present invention avoids the need for a “prepolymer” stage and, therefore, the need for a two-stage process for the manufacture thereof.

As should be apparent, a one-stage process offers economic advantages because one fewer step is needed by comparison with a two-step process. Other advantages of a one-shot process should be apparent to those skilled in the art.

With respect to the method of the present invention, it is contemplated that the reaction between the MDI and the polyols will take place at ambient temperature. Specifically, the reaction is contemplated to take place at about 70° F. (25° C.).

While ambient temperature is contemplated for the reaction, it is also contemplated that the reaction may take place at a higher or a lower temperature without departing from the scope of the present invention. Specifically, the reaction may take place within a range of ±30° F. (16.7° C.) from ambient, within a range of ±20° F. (11.1° C.) from ambient, within a range of ±15° F. (8.3° C.) from ambient, within a range of ±10° F. (5.6° C.) from ambient, or within a range of ±5° F. (2.8° C.) from ambient.

In addition, the foam of the present invention may be formed by a polyurethane foam reaction that includes a catalyst, such as an amine catalyst, a reactive type amine catalyst, and/or a metal catalyst.

It is preferred that the reaction of the present invention be conducted in the absence (or to the exclusion) of a metal catalyst. Metal catalysts typically will be deposited on the surface of the resulting foam, because the metal is not consumed or otherwise bound into the foam structure. Since the foam of the present invention may be used for medical purposes, certain metals may not be considered as acceptable impurities, if deposited on the surface of such foams.

It is also contemplated that the reaction of the present invention will include a reactive type amine catalyst instead of an amine catalyst. Reactive type amine catalysts react with the isocyanate, thereby preventing the release of amine catalyst after the foam is manufactured. In other words, the reactive amine catalyst does not leave a residue on (or in) the foam after the foam has been manufactured. As a result, foams manufactured with a reactive amine catalyst are more suitable for use in medical applications.

As should be apparent to those skilled in the art, an amine catalyst accelerates the blowing reaction. A metal catalyst accelerates the gelling reaction.

If the foam of the present invention is formed without using a metal catalyst, the hydrophilic polyurethane foam is anticipated to be more cost effective to produce. Simply, without the additional ingredient, the foam should be cheaper to make.

In addition, it is contemplated that the foam of the present invention will be employed in one or more medical contexts. Specifically, the foam of the present invention may be incorporated as the absorptive material in a wound dressing and/or bandage. The foam may be used to absorb bodily fluids, such as blood, for example.

For foams used in medical applications, there is a preference for materials that include as few extraneous materials as practicable. As such, the absence of a metal catalyst decreases the amount of different materials that may remain on (or in) the foam to interface with a person's wound. For example, the absence of the use of a metal catalyst assures that the foam will not incorporate any metals therein.

While the present invention contemplates that the foam will exclude metal catalysts, there is an appreciation that some metals (and, therefore, catalysts made from those metals) may be suitable or beneficial in the medical context. For example, silver and copper are known to possess antimicrobial properties (i.e., antibacterial, antiviral, and/or antifungal properties). Accordingly, employing silver and/or copper as a metal catalyst may result in a foam with desirable characteristics.

In addition, as discussed above, the use of a reactive type amine catalyst reduces and/or eliminates the presence of extraneous amine catalyst in the resulting foam. This is considered to be of additional benefit for medical applications, as noted above.

As should be apparent to those skilled in the art, foams made for medical purposes are required to pass cytotoxic tests and other requirements set by the U.S. Food and Drug Administration (“FDA”), as well as other health-related agencies worldwide. By excluding an amine catalyst and/or a metal catalyst, there are fewer materials that may be extracted from the foam during qualifying tests. As a result, the foam is expected to be better able to pass the various tests set by health agencies worldwide.

While a metal catalyst-free construction is contemplated, the present invention is intended to encompass embodiments that rely on one or more catalysts. As noted above, for example, in one alternate embodiment, the process includes adding a reactive type of amine catalyst to the methylene diphenyl diisocyanate (MDI) and polyols.

Table #1, which is provided below, illustrates three specific examples of selected foams according to the present invention. They are listed as “Example 1,” “Example 2,” and “Example 3.” The compositional properties of these three foams are juxtaposed next to a “Comparison,” which is representative of one or more foams produced according to the prior art. Selected properties of the four foams also are provided in Table #1.

Unless otherwise specified, the units for the values in Table #1 is “parts.” As should be understood by those skilled in the art, “parts” is intended to be to a unitless value that refers to a comparative quantity associated with each of the ingredients.

TABLE #1

| | Example 1 | Example 2 | Example 3 | Comparison 1 |
|---|---|---|---|---|
| FE12-70 | 100 | 90 | 30 | 0 |
| P726 | 0 | 10 | 70 | 100 |
| B8244 | 0.7 | 0.5 | 1.0 | 1.5 |
| NE500 | 0.3 | 0.3 | 0.5 | 0.3 |
| NE300 | 0.2 | 0.2 | 0.1 | 0.2 |
| Water | 3.5 | 3.5 | 3.5 | 3.5 |
| T-9 | 0 | 0 | 0 | 0.25 |
| S6510 | 76.5 | 75.1 | 66.5 | 0 |
| T-80 | 0 | 0 | 0 | 44.9 |
| EO (%) | 100 | 90 | 30 | 0 |
| Density (pcf) | 2.8 | 2.9 | 3.0 | 2.8 |
| Absorption (sec) | 1 | 1 | 20 | >600 |

“FE12-70” refers to a polyether polyol that is available from Huntsman, Inc., with a business address at 10003 Woodloch Forest Drive, The Woodlands, Texas 77380. The polyether polyol has an ethylene oxide (“EO”) content of 100% and a hydroxyl value (“OHV”) of 170.
“P726” refers to a polyether polyol that is available from BASF, Inc., with a business address at 100 Park Avenue, Florham Park, New Jersey 07932. P726 has an ethylene oxide content of 0% and a hydroxyl value of 56.
“B8244” refers to a silicone surfactant that is available from Evonik Industries AG, having a business address at Rellinghauser Straβe 1-11, 45128 Essen, Germany.
“NE-500” refers to a reactive amine catalyst, available from Airproducts, Inc., with a hydroxyl value of 283. Airproducts, Inc., has a business address at 7201 Hamilton Blvd., Allentown, Pennsylvania 18195-1501.
“NE-300” refers to a reactive amine catalyst, also available from Airproducts, Inc., with a hydroxyl value of 276.
“T-9” refers to a tin catalyst (i.e., a metal catalyst) available from Airproducts, Inc.
“S6510” refers to MDI that is available from Huntsman, Inc.
“T-80” refers to a toluene diisocyanate that is available from Bayer Corporation, with a business address at 100 Bayer Road, Building 4, Pittsburgh, PA 15205-9741.

As should be apparent, while the three examples provided above list specific ingredients that are contemplated for manufacture of the foam of the present invention, the specific ingredients are not required to practice the present invention. It is contemplated that chemical components and ingredients may be obtained from any suitable source without departing from the scope of the present invention.

As should be apparent from Table #1, when the EO content of the foam is 90% or 100% by weight, the foam exhibits rapid absorption of about 1 second or less. It is noted that the time of 1 second is not an exact measurement and is intended to encompass times that are shorter than 1 second, as indicated above. This suggests that that, when the EO content is at least 90% by weight, this results in a foam with an extremely short absorption time (i.e., 1 second or less).

It is noted that absorption of water is less than 20 seconds when the EO content is greater than 30% by weight. Since an absorption time of 20 seconds or less is considered to be a rapid absorption time, it is contemplated that the foam of the present invention encompasses foams with an EO content of about 30-100% by weight. In an alternative embodiment, the EO content is between about 50-100% by weight. In a further embodiment, the EO content is between about 70-100% by weight. Another embodiment contemplates that the EO content is between about 80-100% by weight. Finally, as noted above, the present invention also contemplates that the EO content is between about 90-100% by weight.

As indicated in Table #1, it is contemplated that the foam of the present invention has a density of between about 2.8 to 2.9 pcf (pounds per cubic foot) (0.045-0.046 g/cm³). The foam of the present invention may exhibit a larger or smaller density without departing from the scope of the present invention. Specifically, it is contemplated that the foam may have a density of about 2.6-3.0 pcf (0.042-0.048 g/cm³) or about 2.5-3.1 pcf (0.040-0.050 g/cm³) while remaining within the scope of the present invention.

In addition, as indicated in Table #1, the surfactant content added to the mixture forming the foam of the present invention may vary between about 0.5-1.0 parts, with about 0.5-0.7 parts providing superior results. In alternative embodiments, it is contemplated that the surfactant content may fall within a broader range of about 0.4-0.8 parts, about 0.3-0.9 parts, about 0.2-1.0 parts, or about 0.1-1.1 parts, without departing from the scope of the present invention.

Concerning the reactive amine catalyst added to the mixture forming the foam, the present invention contemplates a content of about 0.5-0.6 parts, as indicated in Table #1. It is noted that the reactive amine catalyst reported in Table #1 is the combination of two commercially available reactive amine catalysts NE500 and NE 300. In alternative embodiments of the present invention, the reactive amine catalyst may be provided with a broader content of about 0.3-0.8 parts or about 0.4-0.7 parts. As indicated, 0.5 and 0.6 parts provide the desired results with respect to the wicking properties of the foam of the present invention.

With respect to the water content added to the mixture forming the foam of the present invention, Table #1 indicates that 3.5 parts results in foam with desirable characteristics. It is noted, however, that the water content may vary from the precise amount listed in Table #1 without departing from the scope of the present invention. For example, the foam of the present invention may be made from a combination of components where water is between about 3.0-4.0 parts, between about 2.5-4.5 parts, or between about 2.0-5.0 parts.

The MDI content of the mixture resulting in the foam of the present invention (which is represented by S6510 in Table #1) is contemplated to lie between about 66.5-76.5 parts, as shown in Table #1. While the manufacture of the foam of the present invention is contemplated to rely on an MDI content of between about 75.0-77.0 parts for an absorption time of 1 sec or less, a greater amount of MDI may be present in the mixture without departing from the scope of the present invention. For example, it is contemplated that the MDI content broadly may be between about 60.0-85.0 parts. Specific ranges for the MDI content may be between about 73.0-79.0 parts, between 71.0-81.0 parts, between about 69.0-83.0 parts, or 67.0-85.0 parts, for example.

As also indicated in Table #1, the absorption time of the foam of the present invention is contemplated to be less than about 20 seconds. Preferably, the absorption time is less than about 30 seconds. Even more preferably, the absorption time is about 1 second or less, as indicated above.

While the present invention is described in connection with one or more contemplated embodiments, the present invention is intended to encompass variations and equivalents that should be apparent to those skilled in the art. In other words, the present invention should not be understood to be limited to the embodiments described herein.

What is claimed is:

1. A method for making hydrophilic polyurethane foam, comprising:
providing methylene diphenyl diisocyanate;
mixing polyether polyols with the methylene diphenyl diisocyanate; and
allowing the methylene diphenyl diisocyanate and the polyether polyols to form the hydrophilic polyurethane foam,
wherein the hydrophilic polyurethane foam has a content of ethylene oxide that is between about 30-100% by weight,
wherein the methylene diphenyl diisocyanate and polyols are mixed in a one-stage process, and
wherein the hydrophilic polyurethane foam absorbs water in time period that is less than about 30 seconds.

2. The method of claim 1, wherein the content of the ethylene oxide is between about 50-100% by weight.

3. The method of claim 2, wherein the content of the ethylene oxide is between about 70-100% by weight.

4. The method of claim 3, wherein the content of the ethylene oxide is between about 80-100% by weight.

5. The method of claim 6, wherein the content of the ethylene oxide is between about 90-100% by weight.

6. The method of claim 1, wherein the time period is less than about 20 seconds.

7. The method of claim 6, wherein the time period is less than about 2 seconds.

8. The method of claim 7, wherein the time period is less than about 1 second.

9. The method of claim 1, wherein the method excludes the use of any metal catalysts.

10. The method of claim 1, further comprising:
adding a reactive type of amine catalyst to the methylene diphenyl diisocyanate and polyether polyols.

11. A hydrophilic polyurethane foam, comprising:
methylene diphenyl diisocyanate; and
polyether polyols;
wherein the hydrophilic polyurethane foam has a content of ethylene oxide that is between about 30-100% by weight,
wherein the methylene diphenyl diisocyanate and polyols are mixed in a one-stage process, and
wherein the hydrophilic polyurethane foam absorbs water in time period that is less than about 30 seconds.

12. The foam of claim 11, wherein the content of the ethylene oxide is between about 50-100% by weight.

13. The foam of claim 12, wherein the content of the ethylene oxide is between about 70-100% by weight.

14. The foam of claim 13, wherein the content of the ethylene oxide is between about 80-100% by weight.

15. The foam of claim 14, wherein the content of the ethylene oxide is between about 90-100% by weight.

16. The foam of claim 11, wherein the time period is less than about 20 seconds.

17. The foam of claim 16, wherein the time period is less than about 2 seconds.

18. The foam of claim 17, wherein the time period is less than about 1 second.

19. The foam of claim 11, wherein the foam excludes the use of any metal catalysts.

20. The foam of claim 11, further comprising:
a reactive type of amine catalyst added to the methylene diphenyl diisocyanate and polyether polyols.
